(19) United States
(12) Patent Application Publication
(10) Pub. No.: US 2012/0008833 A1
(43) Pub. Date: Jan. 12, 2012

(54) SYSTEM AND METHOD FOR CENTER CURVE DISPLACEMENT MAPPING

(76) Inventors: Ting Song, Clarksburg, MD (US); Vincent B. Ho, N. Bethesda, MD (US)

(21) Appl. No.: 12/833,428

(22) Filed: Jul. 9, 2010

(51) Int. Cl. G06K 9/00

(52) U.S. Cl. 382/106

(57) ABSTRACT

A system and method for center point trajectory mapping includes a computer readable storage medium having stored thereon a computer program comprises instructions, which when executed by a computer, cause the computer to obtain a first plurality of images, each image comprising an unmasked portion and a masked portion, and to calculate a center curve in the unmasked portion in each of the first plurality of images. The instructions further cause the computer to calculate a displacement of the center curve in each of the first plurality of images from a reference center curve, plot a map based on the calculated displacements, and display the map on a display.

### BACKGROUND OF THE INVENTION

Embodiments of the invention relate generally to cavity wall function and, more particularly, to mapping of a deviation of the center curve of the cavity.

The assessment of ventricular wall motion is important in patients with suspected or known cardiac disease since it provides a direct measure of cardiac function. Ventricular wall motion evaluation is used for clinical decision-making regarding the response to and/or need for more aggressive medical and/or interventional therapy (e.g. coronary revascularization surgery or cardiac resynchronization therapy). The non-invasive evaluation of ventricular wall motion is typically performed during rest, exercise, or while under pharmacologic stress and may be based on an imaging modality such as echocardiography, radionuclide imaging, magnetic resonance imaging (MRI), or computed tomography (CT).

Traditional assessments of wall motion during rest or stress include global parameters of left ventricular volumes and ventricular ejection fraction (EF), which is derived from ventricular volume determinations. However, it is not uncommon for patients with mild forms of cardiac disease (e.g., small myocardial infarction) to exhibit only regional wall motion abnormalities while preserving their global parameters (i.e., normal ejection fraction). Detection and quantification of regional wall motion changes are important for early disease detection, surveillance of disease progression, and/or assessment of therapeutic outcome. Regional wall motion analysis is also important for provocative cardiac function testing such as dobutamine stress testing for myocardial viability.

Many wall motion assessment techniques using MRI rely on short-axis imaging planes, which inherently preclude assessment of the ventricular apex. Also, many traditional long axis quantitative myocardial function analyses use wall thickness, which requires challenging epicardial boundary segmentation. With little difference between the signal intensity of epicardium and neighboring tissue (e.g. lung parenchyma), it is difficult to achieve reliable and accurate epicardium segmentation for proper determination of myocardial wall thickness, mass or volume.

Regional wall motion assessment can be performed visually, but inter- and intra-observer agreement is often less than optimal and highly dependent on reader expertise and experience. More quantitative assessment of regional wall motion can be determined using computer assisted measurement of regional ejection fraction, whereby regional sub-volume ejection fractions are determined, or by measurement of segmental wall thickening. Specific imaging techniques that directly measure the movement of the myocardial wall such as tissue Doppler using echocardiography and specialized MRI pulse sequences (e.g., DENSE or myocardial tagging) are known. These echocardiographic and MR imaging techniques, however, use additional time to acquire specialized data sets and for operator-initiated image post-processing. Some of these quantitative methods can track changes over time and can be used to determine intra- or inter-ventricular mechanical dyssynchrony. Despite the large number of available methods, however, visual assessment (i.e., a qualitative method) of wall motion is still the most widely used, but its application is heavily reliant on observer experience and expertise. Quantitative methods such as those described above are associated with a variety of limitations including prolonged image acquisition times, high observer interactive time and expertise requirements, inherently high spatial and/or temporal resolution requirements, and/or high imaging data/processing requirements.

It would therefore be desirable to have an apparatus and method capable of quantitatively assessing cavity wall motion efficiently while reducing variations in observer-based assessments.

### BRIEF DESCRIPTION OF THE INVENTION

According to an aspect of the invention, a computer readable storage medium having stored thereon a computer program comprises instructions, which when executed by a computer, cause the computer to obtain a first plurality of images, each image comprising an unmasked portion and a masked portion, and to calculate a center curve in the unmasked portion in each of the first plurality of images. The instructions further cause the computer to calculate a displacement of the center curve in each of the first plurality of images from a reference center curve, plot a map based on the calculated displacements, and display the map on a display.

According to another aspect of the invention, a method comprises obtaining a plurality of masked images, each masked image comprising an unmasked portion and a masked portion. The method also includes locating a center curve of the unmasked portion in each of the plurality of masked images, generating a map based on a positional relationship of the center curves to a reference center curve, and displaying the generated map on a display.

According to yet another aspect of the invention, a computer readable storage medium having stored thereon a computer program comprising instructions, which when executed by a computer, cause the computer to obtain a plurality of images, each image comprising a masked region and an unmasked region, and to locate a center curve of the unmasked region in each of the plurality of images. The instructions further cause the computer to plot at least one map based on changes in center curves relative to a reference center curve, and display the at least one map to a user.

Various other features and advantages will be made apparent from the following detailed description and the drawings.

### BRIEF DESCRIPTION OF THE DRAWINGS

The drawings illustrate embodiments presently contemplated for carrying out the invention.

In the drawings:

FIG. 1 is a flowchart illustrating a technique for center curve displacement mapping according to an embodiment of the invention.

FIGS. 2-5 are schematic diagrams graphically illustrating a portion of the steps of the technique of FIG. 1 according to an embodiment of the invention.

FIGS. 6-11 are exemplary center curve displacement maps according to embodiments of the invention.

FIG. 12 illustrates a right ventricle ROI binary mask image according to an embodiment of the invention.

FIG. 13 is a schematic block diagram of an exemplary system incorporating an embodiment of the invention.

FIG. 14 is a schematic block diagram of an exemplary MR imaging system incorporating an embodiment of the invention.

### DETAILED DESCRIPTION

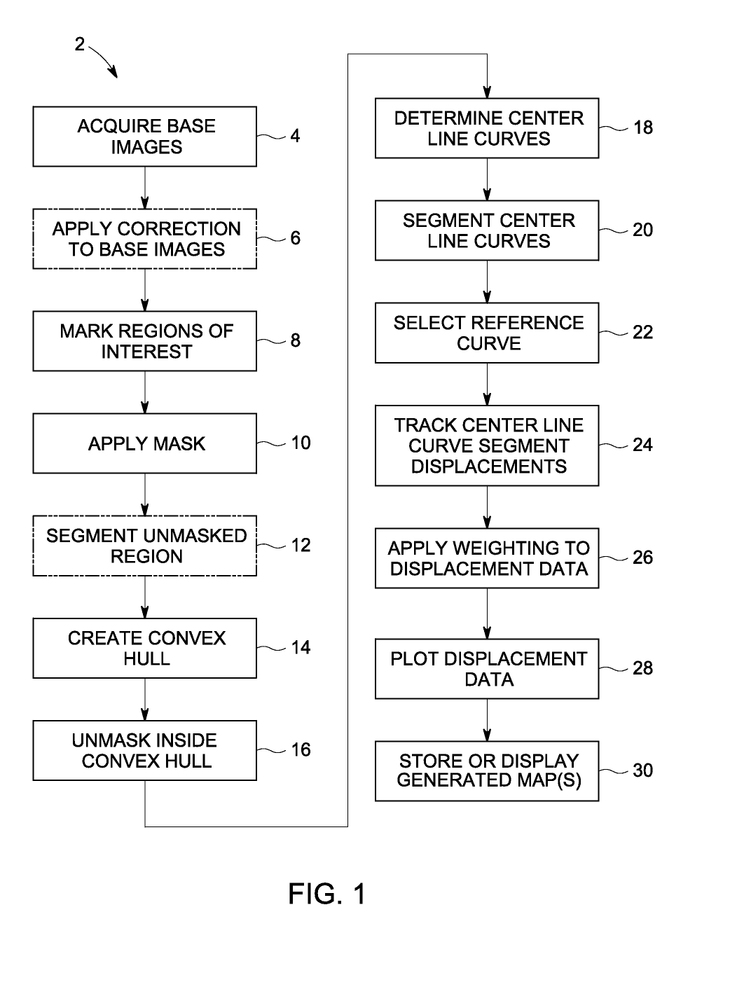

FIG. 1 shows a technique 2 for center curve deviation mapping according to an embodiment of the invention. The technique 2 may be used to quantify center curve displacement of a cavity. A composite of cavity wall motion, such as ventricular wall motion of a heart, can be summarized during the various cardiac phases of the heart in the movement of the center curve of the ventricular chamber throughout the cardiac phases. Technique 2 includes the tracking of the cavity center curve over time such as, for example, over a cardiac cycle (i.e. during both systole and diastole). In this manner, quantitative measurements such as pattern and amplitude for regional as well as global wall motion abnormalities may be determined. Changes in center curve pattern and amplitude can be used to assess myocardial response during exercise (e.g., treadmill or hand grip), during pharmacology (e.g., dobutamine or adenosine) stress testing, or following therapeutic intervention (e.g., medication regimen or percutaneous coronary intervention).

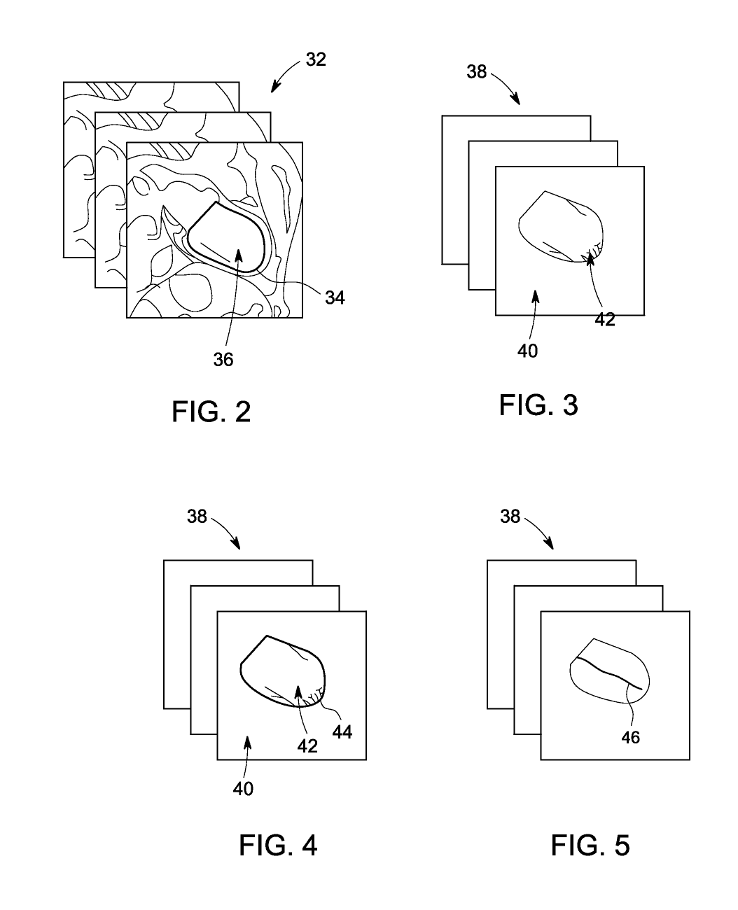

Referring to FIGS. 1 and 2, technique 2 includes acquiring a plurality of base images 32 (shown in FIG. 2) at block 4. Acquiring the base images 32 may include performing an imaging scan and reconstructing images from the imaging scan or may include acquiring stored images previously reconstructed. Acquiring stored images allows quantification of center curve trajectory or displacement movement of a patient without having to re-scan the patient. According to an embodiment of the invention, the base images may be from any imaging modality. For example, the base images may include echocardiography images, radionuclide imaging images, magnetic resonance images, computed tomography images, x-ray images, or ultrasound images. In addition, the base images may be based on any type of scanning sequence or imaging parameter setup. In an embodiment, the plurality of base images are ordered in a consecutive or chronological series of images. For example, cardiac images of a patient may sequentially illustrate ventricular wall motion through a full cardiac cycle (e.g., through the systole and diastole phases). As shown in FIG. 2, images 32 are chronologically ordered and represent twenty, two-dimensional images acquired during a full cardiac cycle. The base images 32 at block 4 may be two-dimensional images or three-dimensional images acquired from an image storage database or acquired in real time. Acquiring images from an image storage database allows any patient images to be used whether the images were recently acquired or were acquired weeks, months, or even years beforehand.

Referring to FIG. 1, a correction may be applied to the base images 32 at block 6 to remove any artifacts that may be present. For example, if the base images are MR images, an inhomogeneity correction may be applied to the base images to correct inhomogeneity artifacts. Other types of corrections may also be applied (e.g., based on the type of imaging modality used to generate the base images) and are contemplated herein. It is also contemplated that a correction may not be applied to the base images if desired. Accordingly, block 6 is shown with dashed lines and may be removed from technique 2 according to an embodiment of the invention.

Referring to FIGS. 1 and 2, a region of interest (ROI) is marked in each of the base images at block 8. The ROIs may be, for example, the left ventricle of a patient's heart as shown in FIG. 2. ROI marking includes delineating a border 34 of a cavity 36 of the ROI in each of the base images 32. ROI marking may include automatically marking the cavities 36 using connected pieces based on signal intensity values of the cavities 36 in the base images. In addition or alternatively thereto, a user may select the respective cavities 36 via computer-aided input. It is contemplated that the ROI marking of block 8 may performed prior to correcting the base images 32 at block 6.

Referring to FIGS. 1 and 3, at block 10, a mask is applied to each of the base images 32 (shown in FIG. 2). The masks are configured to mask the portions of the base images outside of the delineated border 34 and convert the images into binary mask images 38. FIG. 3 illustrates a masked portion 40 of images 38 masking a region outside the delineated borders 34 of images 32. An unmasked portion 42 of images 38 corresponds to a region inside the delineated borders 34 of images 32.

According to an embodiment of the invention, the unmasked portions 42 of binary mask images 38 may be segmented at block 12 (shown in dashed lines). Segmenting an ROI into multiple segments allows for a more detailed or focal analysis within each ROI as may be desired for a higher spatial definition of movement.

Referring to FIGS. 1, 4 and 5, a convex hull 44 is created at block 14 to surround any papillary muscle regions adjacent to the cavity 36 or to the unmasked portion 42. All of the area in the convex hull 44 is then unmasked at block 16. A center curve 46, which lies generally along a central long axis of the shape of the unmasked portions 42, is determined or calculated for each unmasked portion 42 or segmented portion in the binary mask images 38 at block 18. To find the center curves 46, the central long axis of the unmasked portion 42 may be first determined, followed by the determination of a midpoint of a section (not shown) perpendicular to the central long axis and extending to the edges of the unmasked portion 42. A width of the perpendicular sections determines a resolution of the center curves 46. According to an embodiment of the invention, calculated center curves 46 from the binary mask images 38 are used for center curve tracking.

Referring to FIG. 1, the center curves 46 in the binary mask images 38 are segmented at block 20. The number of segments into which the center curves may be segmented may be pre-determined or may be input by a user. While a resolution of the displacement data increases as the number of segments increases, the time it takes to process the displacement calculations also increases. Accordingly, there is a tradeoff between the resolution of the data and the time it takes to generate the data. An optimum number of segments take into account a fast processing time and a high diagnostic quality.

At block 22, a reference curve is chosen or selected from which to base the displacement calculations. In one embodiment, one of the center curves 46 in one binary mask images 38 is designated as the reference curve. For example, the reference curve may be chosen from the binary mask image 38 corresponding to the end of the diastolic phase. It is contemplated, however, the binary mask image 38 corresponding to a different cardiac phase may be chosen as the image from which to select and designate the reference curve.

The displacements of the curve segments from their respective reference curve segments are tracked or calculated at block 24. At block 24, a displacement or deviation of each of the center curve segments from its respective or correlating segment of the reference curve is determined. Each displacement indicates both a magnitude and a direction of the displacement from the respective reference curve segment. For example, a positive displacement value may indicate a displacement magnitude on one side of the reference curve, and a negative displacement value may indicate a displacement magnitude on the other side of the reference curve.

At block 26, a plurality of displacement weights are calculated and applied to the displacement data. The number of displacement weights to be calculated corresponds with the number of segments in the center curves. For example, if the center curves are segmented into ten segments, then ten displacement weights are calculated—one for each group of respective segments. One group of respective segments includes all of the first segments of all of the center curves, another group includes all of the second segments of all of the center curves, etc. To find the displacement weight for the group of first segments, a line that extends from one wall of the chamber to an opposite wall of the chamber and perpendicularly to a center axis of the unmasked portion is determined each of the first segments. The displacement weight for the first segment group is then calculated as the change in the length of the longest of these perpendicular lines to the length of the shortest of these perpendicular lines. The displacement weights for the remaining segment groups are similarly calculated.

The displacement weight for each respective group of segments is applied to the calculated displacement values of the individual segments of the respective groups by dividing the displacement values of the group by the displacement weight resulting in values of arbitrary units (a.u.). Weighting in this manner is determined and applied to help distinguish center curve deviation data from a healthy subject from that of a subject with global heart failure. Because the heart wall of the subject with global heart failure does not work efficiently, it may move much less than the wall of the healthy subject. In this case, the displacement or deviation of the center curve may move as little as the center curve of the healthy subject. However, the change of the center curve min/max values is very small compared to that of the efficiently working heart of the healthy subject. Applying the weighting may thus differentiate the relative displacement values between the healthy and non-healthy subjects.

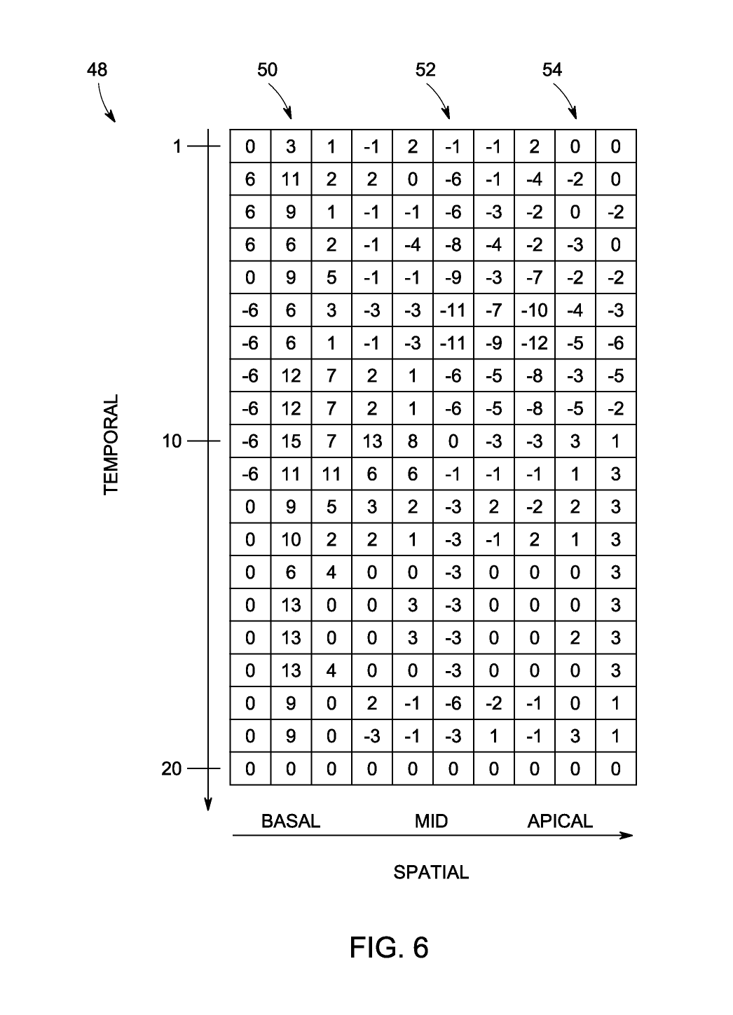

The calculated displacements are plotted on a map at block 28. A temporal vs. spatial displacement map 48 of plotted displacement data is shown in FIG. 6 according to an embodiment of the invention. Displacement map 48 shows a plurality of numerical data plotted on a temporal vs. spatial map. Data from each center curve is plotted according to its temporal position in the cardiac phase. For example, the center curve corresponding to temporal position number one corresponds with the beginning of the systolic cardiac phase, and the center curve corresponding to temporal position number twenty corresponds with the ending of the diastolic cardiac phase. The plotting of magnitudes and directions of center curve segment movement on the map illustrates, for example, the degree of wall motion abnormality and the location indicated by direction in both systolic and diastolic phases of a cardiac phase. The plotting of magnitudes and directions of center curve segment movement on the map also illustrates center curve trajectory patterns useful in diagnoses.

As shown in FIG. 6, each center curve has been segmented into ten segments. The segments are plotted along the horizontal direction according to their spatial position. For example, the segment displacement data plotted in the left-most column of displacement map 48 correspond to center curve segments in the basal region of the cardiac cavity, and the segment displacement data plotted in the right-most column of displacement map 48 correspond to center curve segments in the apical region of the cardiac cavity.

According to another embodiment of the invention, the displacement data in displacement map 48 may be correlated with a plurality of visual indicators, such as grayscale or color values, which may be shown instead of the numerical values of the data as illustrated in FIG. 6. For example, a grayscale or color map of the displacement data may be shown, and areas of large displacement that are associated with particular grayscale or color values may be more readily observable as compared with the numerical data.

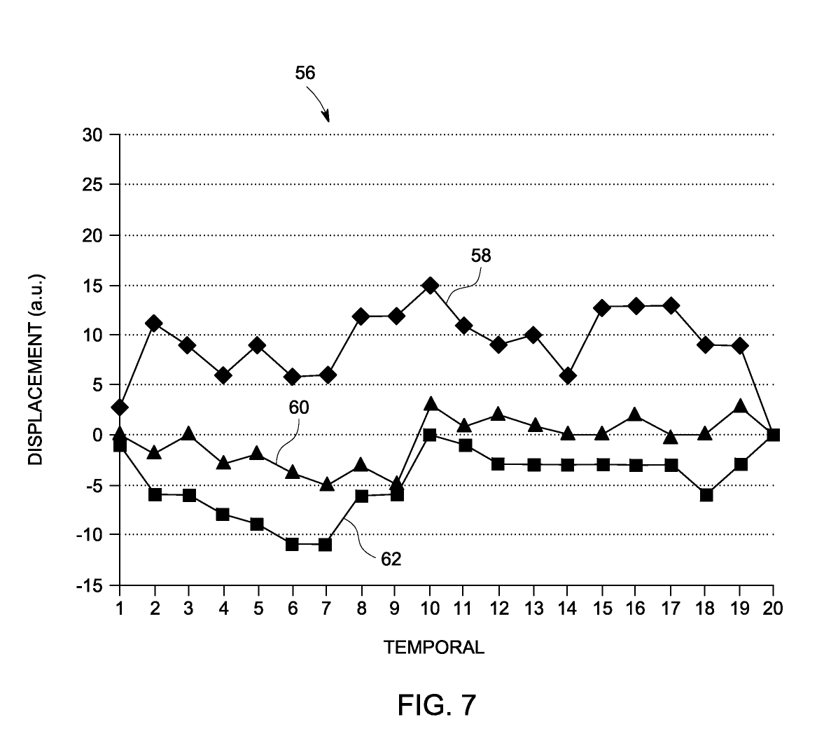

According to another embodiment of the invention, FIG. 7 shows a displacement vs. temporal plot displacement map 56 illustrating another manner in which the displacement data may be shown. Referring to FIGS. 6 and 7, displacement map 56 includes a first curve 58 corresponding to the data of column 50, a second curve 60 corresponding to the data of column 52, and a third curve 62 corresponding to the data of column 54.

Referring back to FIG. 1, center curve displacement maps 48, 56 and their related data may be stored for later use or displayed to a user on a display at block 30.

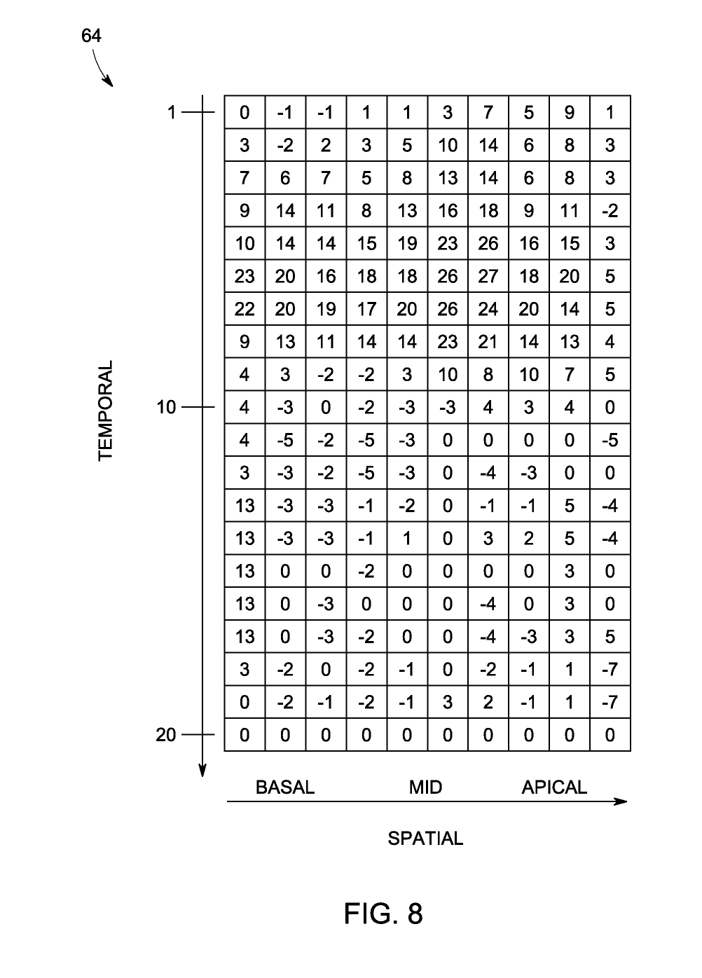

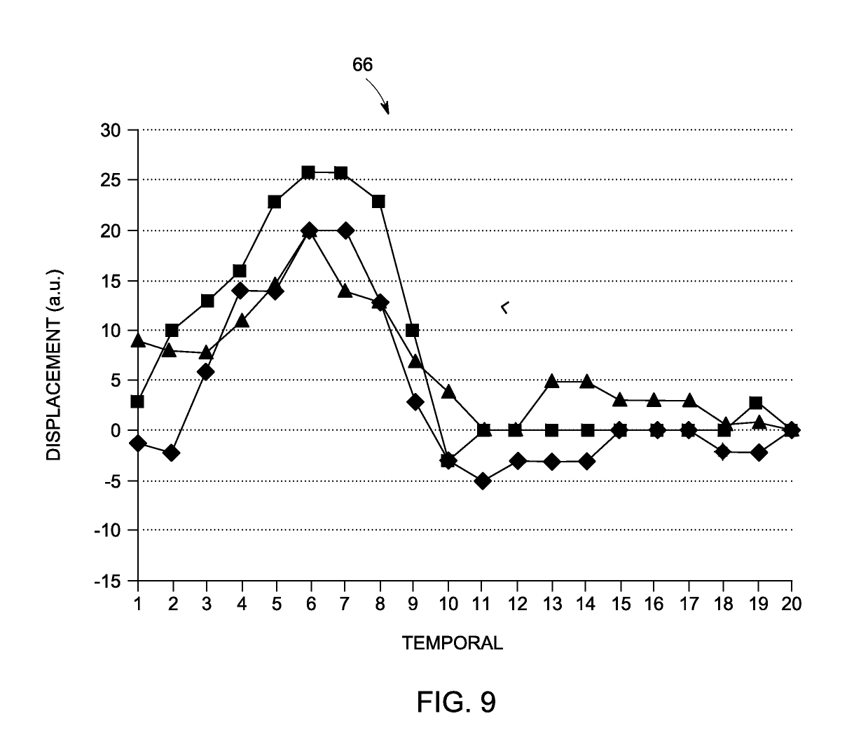

The data in displacement map 48 may be analyzed to determine regions of large magnitude displacement data. Displacement maps 48, 56 of FIGS. 6 and 7 show displacement data that might correspond to a healthy patient, while FIGS. 8 and 9 show displacement maps 64, 66 having displacement data that might correspond to a non-healthy or abnormal patient.

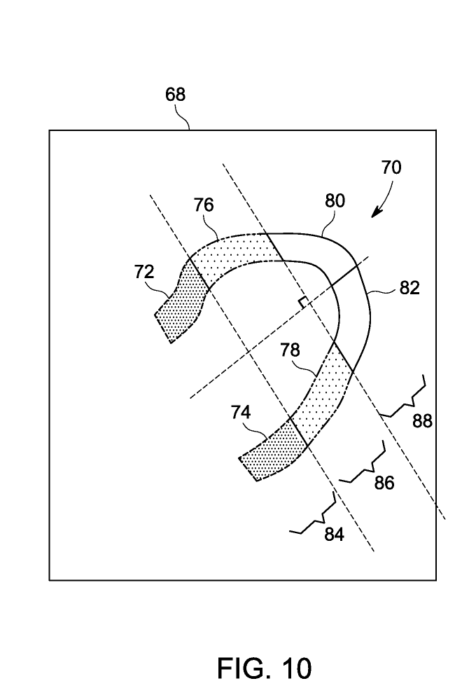

In order to evaluate MR results with other modalities such as echocardiography, for example, a six-segment model center curve displacement map 68 may be plotted at block 28 of FIG. 1. Referring to FIG. 10, a myocardial region overlay 70 may determined from an image such as a base image 32. Myocardial region overlay 70 is then divided into six segments 72-82. In one embodiment, segments 72, 74 respectively correspond to lower and upper regions of a basal region 84 of myocardial region overlay 70, segments 76, 78 respectively correspond to lower and upper regions of a mid or middle region 86 of myocardial region overlay 70, and segments 80, 82 respectively correspond to lower and upper regions of an apical region 88 of myocardial region overlay 70.

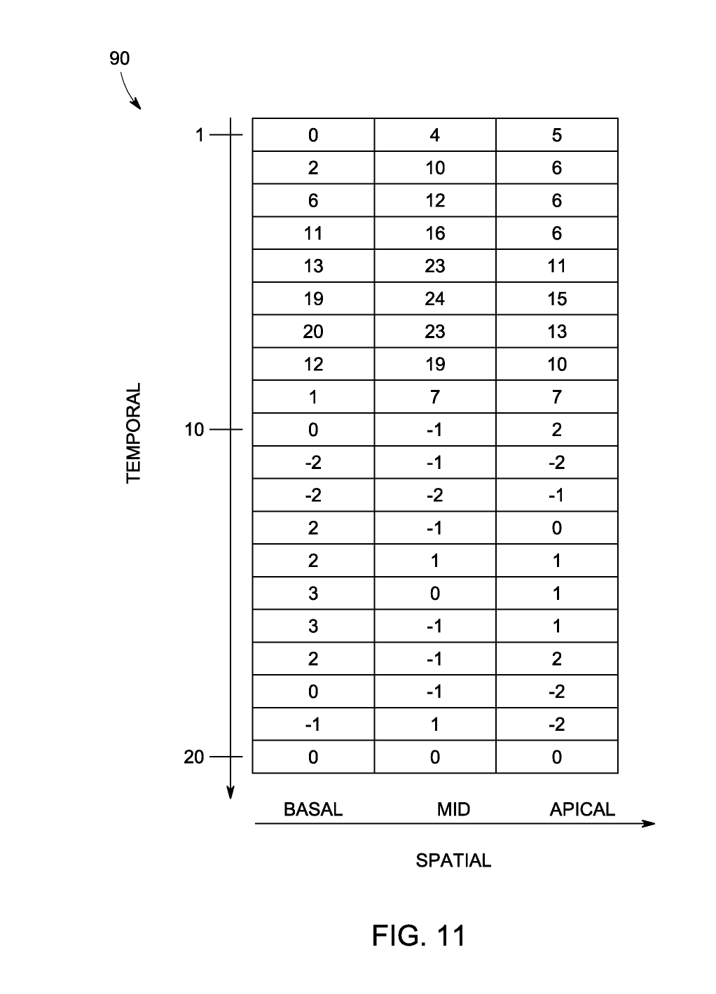

Displacement data for segments 72-82 is determined from averaged displacement data determined through block 26 of FIG. 1. One averaged value for each region (basal, middle, apical) is determined. In one example, FIG. 11 illustrates a displacement map 90 showing an average of displacement data values taken from displacement map 64 of FIG. 8. The basal data in displacement map 90 represents an average of the first four left columns of displacement map 64, the mid data in displacement map 90 represents an average of the next three columns of displacement map 64, and the apical data in displacement map 90 represents an average of the three right columns of displacement map 64.

Referring to FIGS. 10 and 11, the maximum value in each of the columns of displacement map 90 is used as a guide to visually depict myocardial region overlay 70. For example, in the basal, mid, and apical columns of displacement map 90, the maximum absolute/magnitude values are twenty, twenty-four, and fifteen, respectively. The maximum values may be indicated in myocardial region overlay 70 via a grayscale or color value corresponding to the magnitude of the maximum values as well as via numerical indicators inserted into myocardial region overlay 70.

Depending on the magnitude and polarity of the maximum value for each basal, mid, or apical region in displacement map 90, the upper and/or lower regions 72-82 of the basal, mid, or apical regions 84-88 may indicate the degree and/or direction of displacement. In one embodiment, a gradient scale of black or red for zero values to white or yellow, respectively, for values over thirty may indicate the amount of displacement according to a grayscale or color overlay 70.

For example, if the magnitude of the displacement values is greater than or equal to thirty, then both the upper and lower regions are displayed as white or yellow. Displacement values of these magnitudes indicate a global wall motion abnormality.

For example, if the magnitude of the displacement values is less than or equal to ten, then both the upper and lower regions are displayed as black or red. Displacement values of these magnitudes indicate a normal wall motion.

For example, if the magnitude of the displacement values is greater than ten and less than thirty, then the upper segment is filled in with the corresponding gradient grayscale or color value while the lower segment is displayed as black or red if the polarity is positive, and the lower segment is filled in with the corresponding gradient grayscale or color value while the upper segment is displayed as black or red if the polarity is negative. Displacement values of these magnitudes indicate a focal wall motion abnormality.

The generation of a myocardial region overlay in this manner allows an observer to correlate data obtained via an MR or other modality with data found in an echocardiography strain map, for example. One skilled in the art would recognize that other display schemes are possible and are deemed within the scope of the embodiments of the invention.

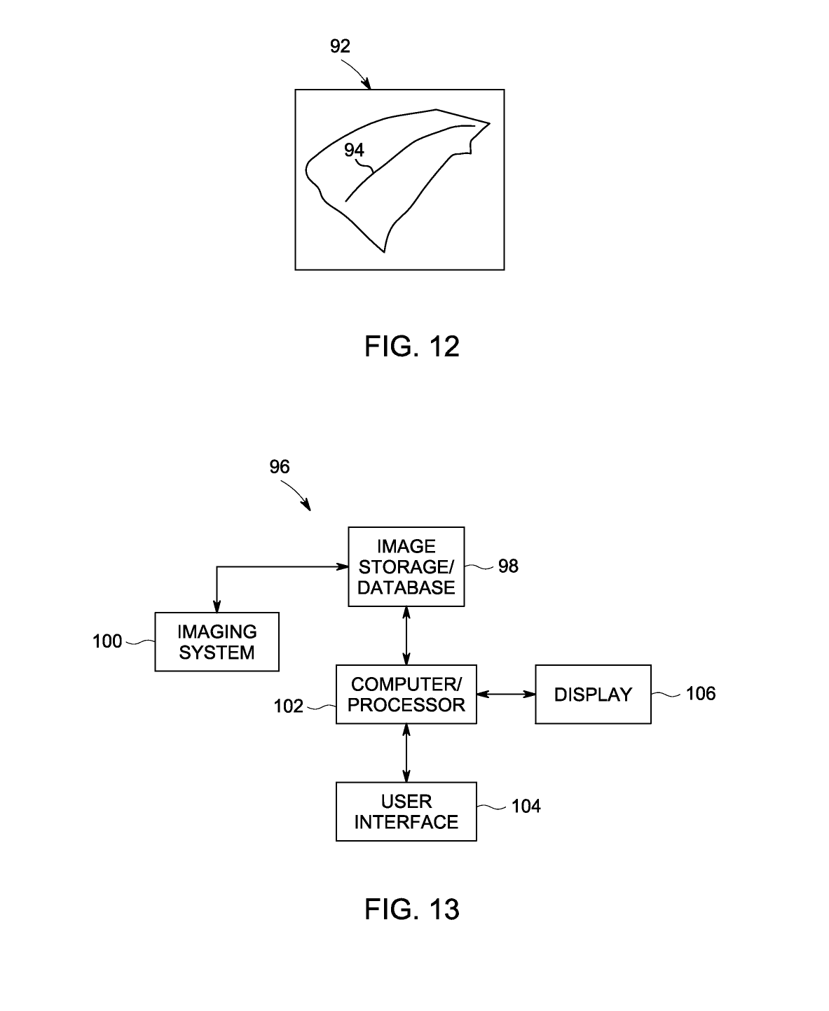

FIG. 12 illustrates a right ventricle ROI binary mask image according to an embodiment of the invention. In FIG. 12, a center curve 92 is shown that was calculated for a right ventricle ROI in a binary mask image 94 of a patient's heart. The techniques as described above may be used to track the center curves of images for other cardiac chambers (e.g., the right ventricle (as shown in FIG. 12), the left atrium, the right atrium, etc.). The techniques described above may also be used to track center curves for ROIs of other hollow chambers such as an esophagus or a stomach of an imaging subject. Embodiments of the invention may be used in clinical tests related to bladder or gallbladder emptying, for example. In addition, it is contemplated that the ROIs may be of any cavity of an imaging subject or object in either a medical or a non-medical setting. Furthermore, the desired ROI cavity may have an irregular shape as illustrated in FIG. 12.

As described above, the base images having the desired ROIs may include images selected from any type of modality including: echocardiography images, radionuclide imaging images, magnetic resonance images, computed tomography images, x-ray images, or ultrasound images based on any type of scanning sequence or imaging parameter setup. It is contemplated that diagnosis of wall motion abnormalities can include the quantification of cavity wall motion abnormalities from one modality compared with the quantification of the cavity wall motion abnormalities from a different modality. Further, as center curve measurements are quantitative, direct comparison of wall motion between different patients is also contemplated.

FIG. 13 is a schematic block diagram of an exemplary system 96 incorporating an embodiment of the invention as an example. System 96 includes an image storage or database 98 configured to store images received from an imaging system 100, for example. According to embodiments of the invention, imaging system 100 is a system capable of imaging an object via any type of modality including magnetic resonance imaging, computed tomography imaging, x-ray imaging, ultrasound imaging, or the like. In addition, images generated by imaging system 100 and stored in image database 98 may be based on any type of scanning sequence or imaging parameter setup

A computer or processor 102 is programmed based on embodiments of the invention such as technique 2 described above with respect to FIG. 1. A user interface 104 allows the computer/processor 102 to receive user instructions such as instructions regarding which images to acquire from database 98 and instructions regarding choosing of the ROI cavities as described above, for example. A display 106 coupled to computer/processor 102 visually depicts any polar maps generated from the images via the computer/processor 102. Additionally, the computer/processor 102 may be programmed to quantify, compare, and display regional or global center curve displacement changes in amplitude over time.

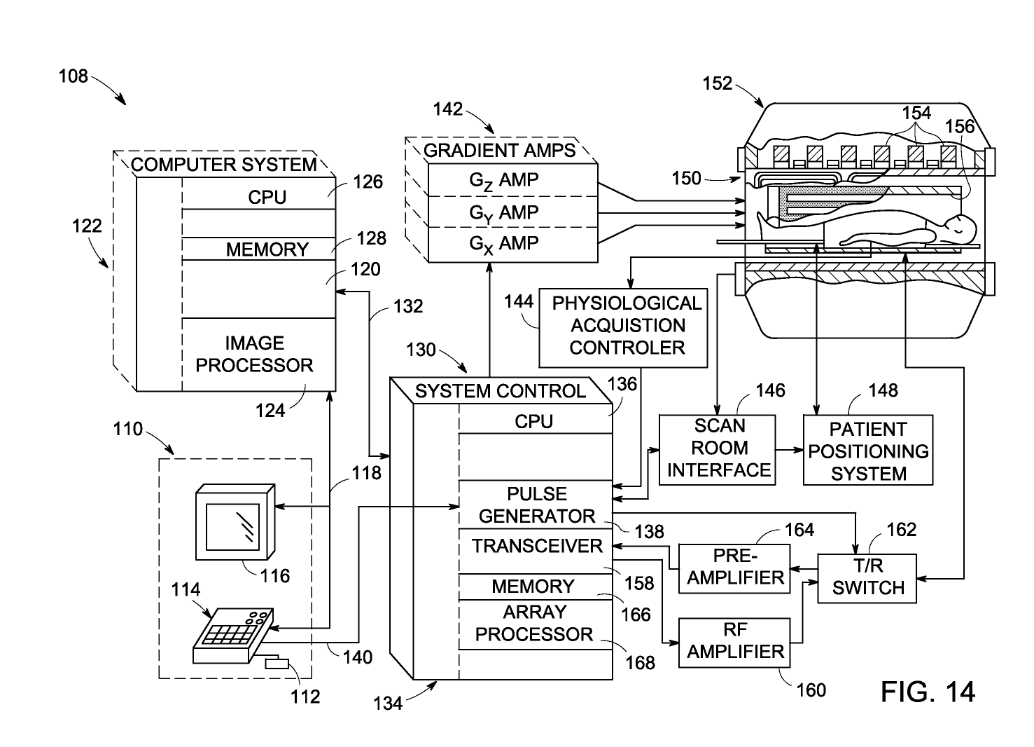

While embodiments of the invention include acquiring images from any of a multiple of imaging modalities, FIG. 14 illustrates the major components of a magnetic resonance imaging (MRI) system 108 incorporating an embodiment of the invention as an example. The operation of the system 108 is controlled from an operator console 110, which includes a keyboard or other input device 112, a control panel 114, and a display screen 116. The console 110 communicates through a link 118 with a separate computer system 120 that enables an operator to control the production and display of images on the display screen 116. The computer system 120 includes a number of modules which communicate with each other through a backplane 122. These include an image processor module 124, a CPU module 126 and a memory module 128 that may include a frame buffer for storing image data arrays. The computer system 120 communicates with a separate system control 130 through a high speed serial link 132. The input device 112 can include a mouse, joystick, keyboard, track ball, touch activated screen, light wand, voice control, or any similar or equivalent input device, and may be used for interactive geometry prescription.

The system control 130 includes a set of modules connected together by a backplane 134. These include a CPU module 136 and a pulse generator module 138 which connects to the operator console 110 through a serial link 140. It is through link 140 that the system control 130 receives commands from the operator to indicate the scan sequence that is to be performed. The pulse generator module 138 operates the system components to carry out the desired scan sequence and produces data which indicates the timing, strength and shape of the RF pulses produced, and the timing and length of the data acquisition window. The pulse generator module 138 connects to a set of gradient amplifiers 142, to indicate the timing and shape of the gradient pulses that are produced during the scan. The pulse generator module 138 can also receive patient data from a physiological acquisition controller 144 that receives signals from a number of different sensors connected to the patient, such as ECG signals from electrodes attached to the patient. And finally, the pulse generator module 138 connects to a scan room interface circuit 146 which receives signals from various sensors associated with the condition of the patient and the magnet system. It is also through the scan room interface circuit 146 that a patient positioning system 148 receives commands to move the patient to the desired position for the scan.

The gradient waveforms produced by the pulse generator module 138 are applied to the gradient amplifier system 142 having Gx, Gy, and Gz amplifiers. Each gradient amplifier excites a corresponding physical gradient coil in a gradient coil assembly generally designated 150 to produce the magnetic field gradients used for spatially encoding acquired signals. The gradient coil assembly 150 forms part of a resonance assembly 152 which includes a polarizing magnet 154 and a whole-body RF coil 156. A transceiver module 158 in the system control 130 produces pulses which are amplified by an RF amplifier 160 and coupled to the RF coil 156 by a transmit/receive switch 162. The resulting signals emitted by the excited nuclei in the patient may be sensed by the same RF coil 156 and coupled through the transmit/receive switch 162 to a preamplifier 164. The amplified MR signals are demodulated, filtered, and digitized in the receiver section of the transceiver 158. The transmit/receive switch 162 is controlled by a signal from the pulse generator module 138 to electrically connect the RF amplifier 160 to the coil 156 during the transmit mode and to connect the preamplifier 164 to the coil 156 during the receive mode. The transmit/receive switch 162 can also enable a separate RF coil (for example, a surface coil) to be used in either the transmit or receive mode.

The MR signals picked up by the RF coil 156 are digitized by the transceiver module 158 and transferred to a memory module 166 in the system control 130. A scan is complete when an array of raw k-space data has been acquired in the memory module 166. This raw k-space data is rearranged into separate k-space data arrays for each image to be reconstructed, and each of these is input to an array processor 168, which operates to Fourier transform the data into an array of image data. This image data is conveyed through the serial link 132 to the computer system 120 where it is stored in memory. In response to commands received from the operator console 110, this image data may be archived in long term storage or it may be further processed by the image processor 124 and conveyed to the operator console 110 and presented on the display 116.

The computer system 120 is programmed to quantify and display maps of center point displacement movement as described above according to an embodiment of the invention. The computer system 120 may retrieve stored images from historical scans or may acquire images during a scan followed thereafter by quantification of center point trajectories and map generation and display as described above according to an embodiment of the invention.

A technical contribution for the disclosed method and apparatus is that it provides for a computer implemented mapping of a deviation of a center curve of a cavity.

Therefore, according to an embodiment of the invention, a computer readable storage medium having stored thereon a computer program comprises instructions, which when executed by a computer, cause the computer to obtain a first plurality of images, each image comprising an unmasked portion and a masked portion, and to calculate a center curve in the unmasked portion in each of the first plurality of images. The instructions further cause the computer to calculate a displacement of the center curve in each of the first plurality of images from a reference center curve, plot a map based on the calculated displacements, and display the map on a display.

According to another embodiment of the invention, a method comprises obtaining a plurality of masked images, each masked image comprising an unmasked portion and a masked portion. The method also includes locating a center curve of the unmasked portion in each of the plurality of masked images, generating a map based on a positional relationship of the center curves to a reference center curve, and displaying the generated map on a display.

According to yet another embodiment of the invention, a computer readable storage medium having stored thereon a computer program comprising instructions, which when executed by a computer, cause the computer to obtain a plurality of images, each image comprising a masked region and an unmasked region, and to locate a center curve of the unmasked region in each of the plurality of images. The instructions further cause the computer to plot at least one map based on changes in center curves relative to a reference center curve, and display the at least one map to a user.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A computer readable storage medium having stored thereon a computer program comprising instructions, which when executed by a computer, cause the computer to:
obtain a first plurality of images, each image comprising an unmasked portion and a masked portion;
calculate a center curve in the unmasked portion in each of the first plurality of images;
calculate a displacement of the center curve in each of the first plurality of images from a reference center curve;
plot a map based on the calculated displacements; and
display the map on a display.

2. The computer readable storage medium of claim 1 having further instructions to cause the computer to select a reference image from the first plurality of images; and
wherein the instructions that cause the computer to calculate the displacement of the center curve in each of the first plurality of images cause the computer to:
calculate the displacement of the center curve in each of the first plurality of images from the center curve of the reference image.

3. The computer readable storage medium of claim 2 having further instructions to cause the computer to select the reference image based on an input from a user.

4. The computer readable storage medium of claim 1 wherein the instructions that cause the computer to calculate the center curve in the unmasked portion in each of the plurality of images cause the computer to:
calculate the center curve along a long axis of the unmasked portion in each of the plurality of images.

5. The computer readable storage medium of claim 1 having further instructions to cause the computer to:
obtain a second plurality of images acquired via an imaging scanner;
mark a region of interest (ROI) in each image of the second plurality of images based on signal intensity values of the ROI; and
apply a mask to a portion of each image of the second plurality of images outside of the marked ROIs.

6. The computer readable storage medium of claim 5 having further instructions to cause the computer to convert the second plurality of images into a plurality of binary mask images, wherein the plurality of binary mask images comprise the first plurality of images.

7. The computer readable storage medium of claim 5 wherein the second plurality of images is one of a plurality of echocardiography images, a plurality of radionuclide imaging images, a plurality of magnetic resonance images, a plurality of computed tomography images, a plurality of x-ray images, and a plurality of ultrasound images.

8. The computer readable storage medium of claim 1 wherein the instructions that cause the computer to calculate the displacement of the center curve in each of the first plurality of images cause the computer to:
calculate the displacement of a plurality of portions of the center curve in each of the first plurality of images from a respective plurality of portions of the center curve of the reference image.

9. The computer readable storage medium of claim 8 wherein the instructions that cause the computer to plot the map cause the computer to:
plot the calculated displacements on a displacement map based on a position of the plurality of portions of the center curve along the center curve and based on an ordered relationship between the calculated displacements and the reference center curve.

10. The computer readable storage medium of claim 9 wherein the ordered relationship comprises a temporal relationship and trajectory between the calculated displacements and the reference center curve.

11. The computer readable storage medium of claim 8 wherein the instructions that cause the computer to plot the map cause the computer to:
associate a color with each of the calculated displacements; and
plot the colors on a color displacement map based on a position of the plurality of portions of the center curve along the center curve and based on an ordered relationship between the calculated displacements and the reference center curve.

12. The computer readable storage medium of claim 11 wherein the ordered relationship comprises a temporal and trajectory relationship between the calculated displacements and the reference center curve.

13. The computer readable storage medium of claim 1 wherein the ROI of each image of the first plurality of images corresponds to one of a left ventricle, a right ventricle, an atrium, an esophagus, and a stomach of an imaging subject.

14. The computer readable storage medium of claim 1 wherein the unmasked portion of each image of the first plurality of images comprises an irregular shape.

15. A method comprising:
obtaining a plurality of masked images, each masked image comprising an unmasked portion and a masked portion;
locating a center curve of the unmasked portion in each of the plurality of masked images;
generating a map based on a positional relationship of the center curves to a reference center curve; and
displaying the generated map on a display.

16. The method of claim 15 wherein generating the map comprises:
dividing each of the center curves and the a reference center curve into a plurality of segments; and
for each segment of the center curves:
calculating a distance of the segment from a respective segment of the reference center curve; and
plotting the calculated distance of the segment in a table, the table comprising data locations corresponding to a position of the segment within the center curve of the segment and corresponding to relationship of the center curve of the segment to other center curves.

17. The method of claim 16 wherein generating the map further comprises converting the data in the table into a color map, wherein each color in the color map indicates a magnitude of distance.

18. A computer readable storage medium having stored thereon a computer program comprising instructions, which when executed by a computer, cause the computer to:
obtain a plurality of images, each image comprising a masked region and an unmasked region;
locate a center curve of the unmasked region in each of the plurality of images;
plot at least one map based on changes in center curves relative to a reference center curve; and
display the at least one map to a user.

19. The computer readable storage medium of claim 18 wherein plotting the at least one map comprises:
determining a distance offset of a plurality of segments of each center curve from a respective plurality of segments of the reference center curve
plotting an absolute center curve displacement map showing graphical indicators correlated to one or more values of the distance offsets.

20. The computer readable storage medium of claim 19 wherein plotting the absolute center curve displacement map comprises plotting a graphical indicator for each distance offset; and
wherein the graphical indicators comprise one of a set of color values and a set of grayscale values corresponding to respective values of distance offsets.

21. The computer readable storage medium of claim 19 wherein plotting at least one map comprises plotting a six-segment model center curve displacement map.
